(19) United States
(12) Patent Application Publication
(10) Pub. No.: US 2010/0178144 A1
(43) Pub. Date: Jul. 15, 2010

(54) PENDULAR CARGO DISPLACER

(76) Inventor: Martin Vestergaard, Roskilde (DK)

Correspondence Address: JAMES C. WRAY, 1493 CHAIN BRIDGE ROAD, SUITE 300, MCLEAN, VA, 22101, US

(21) Appl. No.: 12/452,378

(22) PCT Filed: Jun. 25, 2008
(86) PCT No.: PCT/DK2008/000238

§ 371 Date: Mar. 15, 2010

(30) Foreign Application Priority Data
Jun. 25, 2007 (DK) PA 2007 00915

(51) Int. Cl. B66C 25/00; B66C 1/10; B66C 1/02; B60P 1/54

(52) U.S. Cl. 414/541; 414/680; 414/729; 414/737; 414/800

(57) ABSTRACT

Loading device using a pendular movement for the displacement of cargo. The loading device consists of a pole (2) and a cable (6), which may be attached to a winch (5). The pole may be telescopic enabling the loading device to obtain different heights.

### FIELD OF THE INVENTION

The present invention relates to a loading device for the manually displacement of cargo from one place to another, by means of a pendular motion.

### BACKGROUND OF THE INVENTION

Without the help of loading devices the cargo needs to be displaced by hand. Hence, displacement of cargo from one place to another or eventually from one means of transportation to another may be troublesome and physically demanding depending on the amount and weight of the cargo. During time several devices have been invented in order to ease the physical workload of this displacement.

DE2652543 describes one means for the lifting of heavy cargo. This device contains means for attachment of the cargo in one side and a counterweight on the other side. Both the means for attachment and the counterweight is lifted by connection means, which are able to decrease the distance between the two sides of the device. Displacement of the cargo is then obtained by rotation of the device around a central axis.

Other lifting devices utilize the means of swinging motions similar to that of a pendulum, in order to utilise the gravity force of the cargo itself for the displacement. GB 643,640 is one example of a case, where the cargo in question is lifted by means of a cable and a power source. When lifted above a certain level the cargo gets past the supporting frame of the device and is capable of swinging in a motion similar to a pendulum. The cargo is then manually displaced to the place of off-loading.

### OBJECTS OF THE INVENTION

It is the object of the present invention to construct a loading and/or off-loading device with a pendular movement, that is flexible, easy to handle and with means for several on- and off-loading positions.

### DESCRIPTION OF THE INVENTION

The present invention describes a loading device for on- and off-loading of cargo such as parcels, sacks, baggage and luggage characterised in that the loading device contains a pole and a cable, said pole is at the proximal end attached to a platform, where said platform defines a plane, said cable is arranged between the distal end of the pole and the means for displacement of cargo, which means for displacement is free to perform a pendular motion forced by manually displacement. This enables cargo to be transported easily from one place to the other such as moving luggage from the cargo department of an aircraft to trailers or vehicles for further processing of the luggage either transferring the luggage to another aircraft or for returning it to its respective owners. Similarly, this movement may be in the opposite direction or performed with cargo instead of luggage.

Initially the cable with the means for displacement hangs vertically from the top of the pole. Manually, the displacement means and the cable is pushed towards the on-loading, for example a cargo compartment or the lower end of other off-loading equipment e.g. a conveyer belt, of the cargo to be displaced. Then, the piece of cargo or eventually more pieces of cargo is securely attached to the displacement means before the cable and displacement means are manually led to the terminal point of the destination such as a trailer or a vehicle. At this point the cargo may be off-loaded from the displacement means. During this motion the cable is turned around a point at the distal end of the pole performing a pendular movement implicating that the cable moves similar to a pendulum swing. Only minor force is needed in order to move the cable including displacement means to the on-loading of the cargo. The transfer of the cargo from the on-loading to the terminal point utilizes the gravity force within the pendular movement to swing the cargo without the need of major forces from the person moving the means for displacement. The operator of the device only needs to secure the path of the swinging movement of the cable and means for displacement. Thus, this loading device relieves the physical load upon the back and knees of the operator at work because they do not need to physically transfer the cargo from the on-loading to the terminal point of displacement.

As a further improvement, the pole of the loading device is telescopic, such that the pole may be extended from a storage position to a fully extended state or any desired length in between. This enables the pole to be fully retracted in situations where it is not to be used, which is preferable during situations of transport and storage, where the height of a pole fully extended may be to large for placement within an ordinary garage or the like. The fact that the pole is capable of being of more different lengths, furthermore, increases the ability of the loading device to reach positions at varying heights and varying places without the need for movement of the loading device itself.

A further advantageous embodiment of the invention is that the loading device has the cable arranged on a winch, and said winch is situated beside the proximal end of the pole. Attaching the cable to a winch makes it possible to extend and retract the length of the cable both during the storage position of the loading device with the telescopic pole fully retracted but also during working with the loading device where the length of the cable may be adjusted as appropriate as either the height between the on-loading and the off-loading may differ or the load of the different pieces of cargo may differ. Having a winch to rewind the cable during the retraction of the telescopic pole is highly beneficial due to the fact that the cable otherwise would end up in one large lump. In addition, in the situation in which the pole was not telescopic the use of a winch would be beneficial too, in order to receive a vertical movement of the cable during the displacement of cargo.

A still further improvement would consist of the winch containing sensor means, said sensor means automatically balancing the tension force of said cable according to the load on the means for displacement of luggage keeping the means for displacement in a predefined height. Several pieces of cargo is to be moved by the loading device, however, it is seldom that the individual pieces of cargo are of similar weight and in some cases it may be that more pieces of cargo are transferred at the same time. In order not to lift the cargo during the on- and off-loading it is necessary to adjust the length of the cable. This may be performed by manually adjustment but by utilising this advantageous embodiment containing sensor means the cable will automatically be adjusted to consistently be elevated at a given level in height, thus the cable coordinated with the winch and in response to input from the sensors, provides a substantially neutral load to the personnel operating the device. The tension in the cable obtained by the different pieces of cargo is sensed by the sensor means and the cable is automatically un- or rewind in order to obtain the desired predefined height/load.

In a further advantageous embodiment of the invention the cable is made of an elastic or resilient material, optionally as a tube suitable for vacuum. The elastic or resilient material may be the entire length of the cable or just a part of the cable, for example the end of the cable displaced vertically from the distal end of the pole to the means for displacement. This is an additional beneficial feature, which may be combined with the telescopic pole and/or the winch with or without sensor means. Composing the cable or part of the cable of an elastic material would make it possible for example to adjust the normal level of height or load to the highest place being either the on-loading or the off-loading. During movement, the elasticity of the cable would make it possible to move the cable vertically by pushing in order to compensate for the small differences in height between the on- and off-loading positions. If the cable is made of a tube it is possible to combine the tube with a wire, all of which may be made of an elastic or resilient material. The tube may be connected to a pump next to the winch through which vacuum may be created in order for a sucking disc to function properly.

In a still further advantageous embodiment of the invention the pole comprises means for rotating the pole around an axis at the proximal end, where said axis is arranged vertical to the plane of the platform. This increases the working radius of the loading device without actually having to move the device itself. Since the pole is able to rotate around a vertical axis it may be turned 360 degrees making up a circular movement. Thus, in cases where the loading device is not parked carefully or in cases where it is not possible to place the loading device in an optimal position in accordance with the placement of the on- and off-loading positions the potential of the loading device with reference to pendular movement may still be utilized due to the possibility of manipulating the pole. As a further beneficial possibility, this enables the loading device to be able to load multiple vehicles or trailers with cargo or luggage without being moved just by turning the pole after the loading of the cargo.

The above mentioned abilities of the loading device may further be utilized by the additional improvement wherein the pole comprises means arranged at the proximal end, which means can alter the elevation of the poles distal end relative to the plane of the platform. This improvement, additionally, enables the pole to be in a more or less vertical position, which furthermore may be used for the control of the pendular movement due to the decrease in length of the cable the more horizontal the pole is placed.

In a further advantageous embodiment of the invention the means for displacement of cargo arranged at the end of the cable consists of a flat plate, a fork, a hook or suction means. Different means for displacement may be used for different purposes for example a flat plate may be ideal for transporting suitcases because more small suitcases may be transported at the same time. In other cases, where the cargo to be displaced may be heavy cargo or very bulky cargo other means for displacement may be more appropriate. In order to place suitcases onto a flat plate they have to be pushed, which may be troublesome with large, bulky and heavy cargo. In this case, suction means, such as for example a suction cup may be more appropriate because this is placed onto the top of the cargo, attached and lifted by means of the loading device. In this way, the cargo is displaced with a minimum of physical work from the persons at work. In case, the heavy and bulky cargo is placed upon a pallet a fork may be more appropriate. Finally, a hook may be suitable in cases where ropes are placed around the cargo.

It may be imagined that the means for displacement may be replaceable, enhancing the possible alternative uses of the loading device.

In a still further advantageous embodiment of the invention said platform is placed upon a vehicle or trailer or said platform is an integrated part of a vehicle or trailer. In this way, it is possible to integrate the platform with already existing equipment and thus, the implementation of the loading device may be easier. Great advantage is achieved by placement upon vehicles or trailers since the loading device is easy to transport. In addition, the loading device may be integrated together with the means for transporting the cargo in which case the loading device is to be at the place, where it is needed.

Overall, the different embodiments provides the means for a method for manually moving cargo by means of a pendular movement arising from the displacement of a cable, said cable falls vertically from the distal end of a pole, which pole at its proximal end is attached to a platform. This enables large amounts of cargo to be displaced without involving heavy lifting and with as little physical involvement from persons as necessary. This greatly improves the working environment for persons working daily with the on- and off-loading of cargo, thereby preventing or minimising damages caused by wear and tear. This improves the life of the persons at work as well as increasing the amount of work possible.

### DESCRIPTION OF THE DRAWING

FIG. 1 illustrates an extended pole with a pendular swinging cable integrated on a vehicle,

FIG. 2 illustrates a retracted pole and cable integrated on a vehicle,

FIG. 3 illustrates a top-view of an extended pole integrated on a vehicle, and

FIG. 4 illustrates the ability of the loading device to displace cargo on more subsequent trailers without movement of the loading device itself.

### DETAILED DESCRIPTION OF THE INVENTION

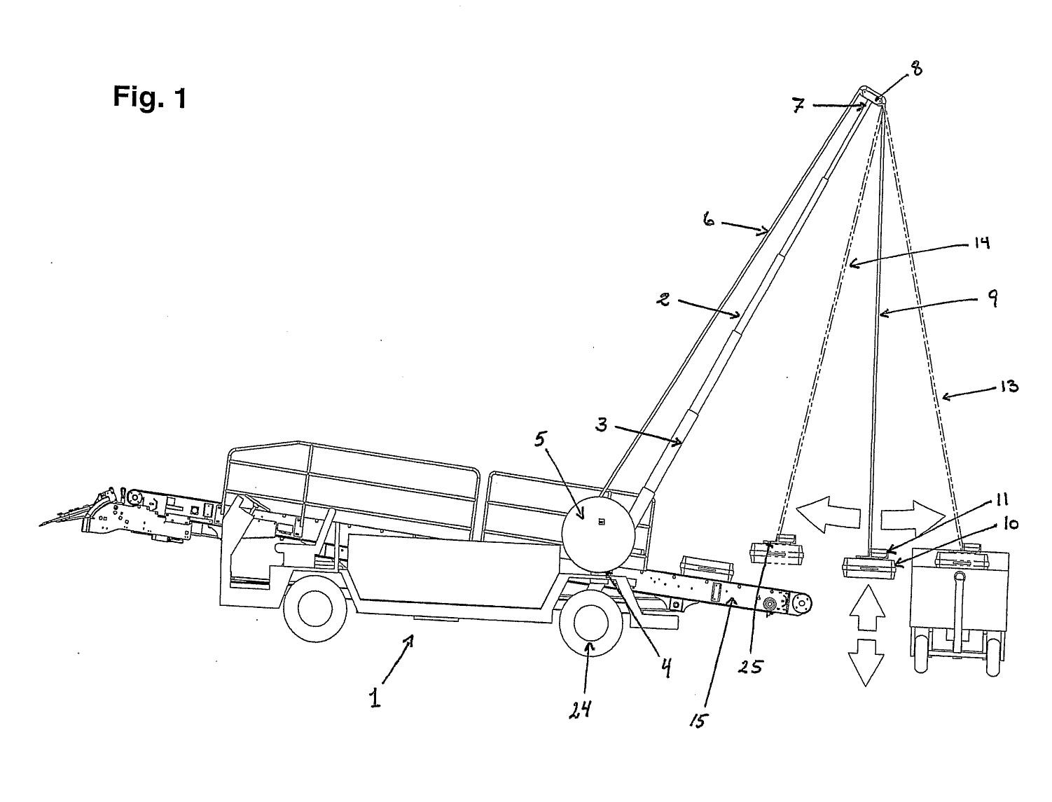

FIG. 1 demonstrates one embodiment of the loading device as integrated on a vehicle 1 designed for displacement of luggage. A pole 2 containing telescopic elements 3 is placed at the rear end of the vehicle with the proximal end 4 of the pole integrated within the chassis of the vehicle just between the back wheels 24. Beside the proximal end 4 of the pole 2 a winch 5 is placed and a cable 6 is attached to the winch 5. The cable 6 runs from the winch 5 along the pole 2 and round the distal end 7 of the pole 2. In this embodiment, a rotating device 8 containing two wheels with a groove within the rim of the wheels wherein the cable 6 slides is situated. The rotating device 8 makes it uncomplicated for the cable 6 to slide without being worn, and hence makes the loading device more durable and secure. From the distal end 7 of the pole 2 the cable 6 hangs vertically 9 and ends with a sucking disc 25 on which a handle 11 for operation may be placed. The luggage 10 to be displaced is fastened by means of e.g. vacuum to the sucking disc 25 and displaced to the place of off-loading. As an alternative the means for displacement may consist of a flat plate, a hook or suction means.

The part of the cable 12 hanging from the rotating device 8 is in this embodiment made of an elastic material. In other embodiments, the cable may be stiff i.e. without resilient properties and may eventually consist of a tube through which vacuum to be used in connection with a sucking disc 25 is created. This enables the cable of smaller vertical displacement, which is of importance in case of minor differences in height between the on- and off-loading positions. For larger differences in height, adjustment of the cable may take place by re- or unwinding the cable at the winch. Along with the winch 5, sensor means may be placed. This influences automatic adjustment of the height of the displacement plate, which due to the elastic properties of the cable may be at different heights, when the weight of the luggage 10 varies.

The cable 12 hanging from the rotating device 8 is capable of a swinging movement similar to that of a pendulum. This pendular movement is an essential feature for displacement of luggage. The cable 6 is moved to a position close to the on-loading place 13, where the cargo is attached underneath the sucking disc 25. Then, the cargo is manually moved back through the vertical position 9 to a position close to the off-loading place 14, where the cargo is released from the sucking disc 25 onto the transporting device 15 on the vehicle 1. In this way, the personal do not need to carry the cargo but only to displace it. Thus, the loading device is sparing the physics of the persons at work.

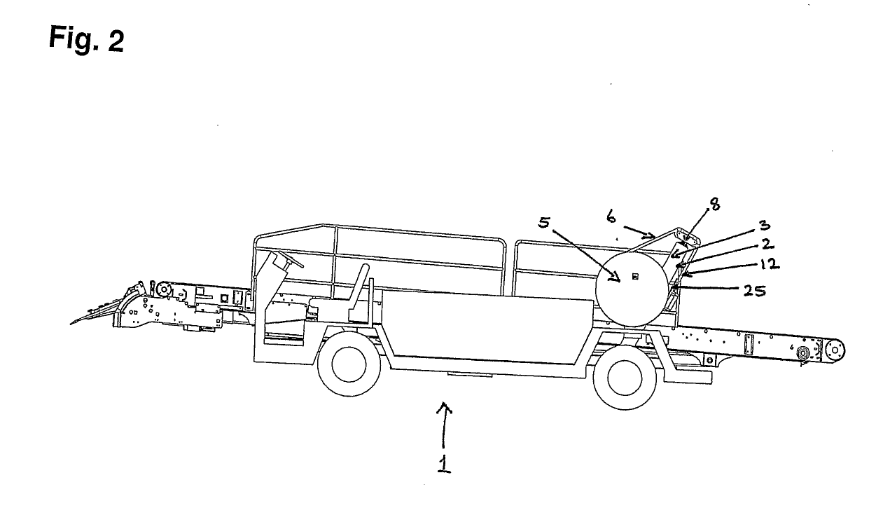

The telescopic elements 3 of the pole 2 result in that the pole 2 may be at an extended, fully retracted or in any desired length in between whatever position may be the most optimal for the displacement of luggage in the given situation and the most sparing on the physics of the persons at works. In FIG. 2 is illustrated a situation where the pole 2 is fully refracted and the cable 6 rewind. In this position, the height of the pole 2 is not much higher than the ordinary height of the vehicle 1, and hence may be stored in garages used for parking of the vehicles without a pole. The cable 6 is rewind onto the winch 5 and follows tightly along the pole 2 around the rotating device 8 and the elastic part of the cable 12 is as rewind as possible. The sucking disc 25 for transporting luggage is flipped and attached to the cable in order for the rewind cable 6 to follow closely along the pole 2.

When the vehicle 1 is to be used, it is transported with the pole 2 fully retracted to the position appropriate. At this place, the pole 2 is extended to the desired position and the cable 6 is continuously rewind from the winch along with the extension of the pole 2. The sucking disc 25 is reattached from the cable 6 and the loading device is ready to use for displacement of luggage.

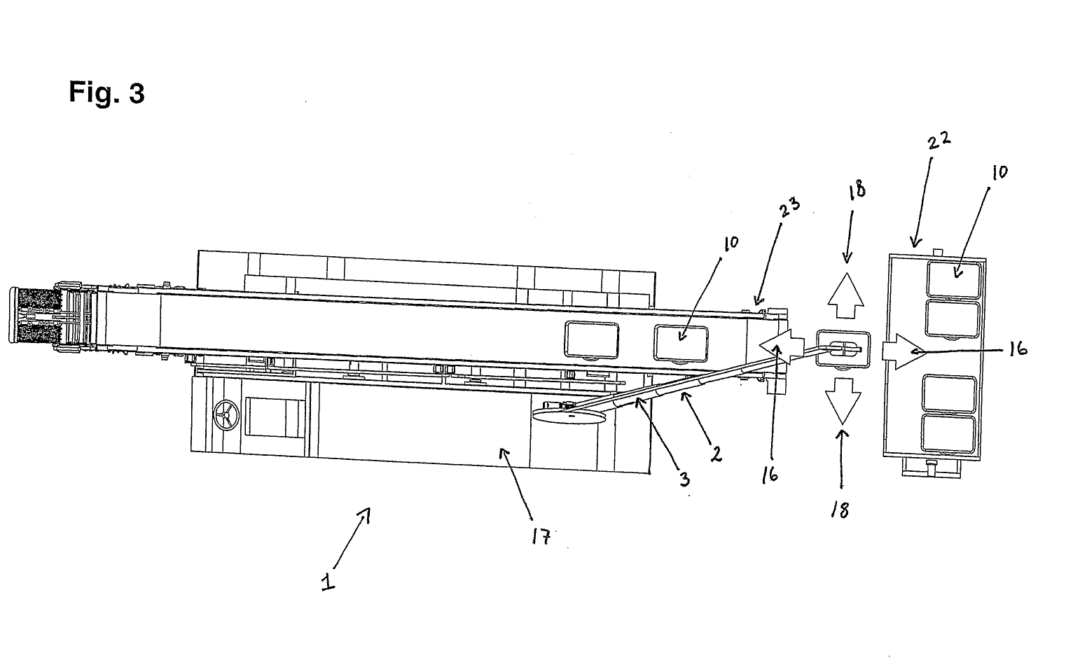

The placement of the vehicle 1 need not be exactly but may be flexible due to the multiple functions of the loading device and luggage 10 may easily be displaced from the place of on-loading 22 to the place of off-loading 23. The telescopic elements 3 of the pole 2 of the loading device enable the pole 2 to be situated in different positions of heights, which result in that the pendular movement of the elastic part of the cable may be of different radius. In addition, this may be a feature of the fact that the pole 2 is capable of achieving different angles compared with the plane of the vehicle 17 as illustrated by the arrows 16 in FIG. 3. This results in the distal end 7 of the pole 2 being elevated or lowered according to the plane of the vehicle 17. Furthermore, the pole 2 may be rotated around an axis at the proximal end, arranged vertical to the plan of the vehicle as illustrated by the arrows 18 in FIG. 3.

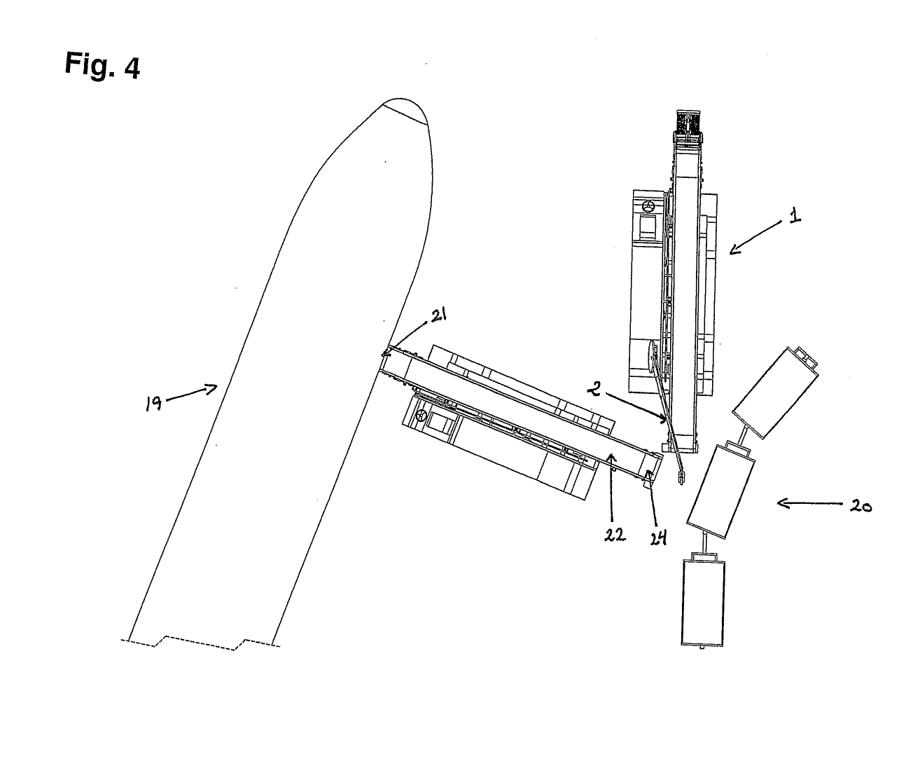

Some of the improved features obtained by rotating the pole 2 are illustrated in FIG. 4. A vehicle 1 with an integrated pole 2 is parked next to an aircraft 19. Next to the aircraft 19 and the vehicle 1, a row of luggage vans 20 is situated. Luggage is loaded from the cargo department 21 onto a conveyer device 22 and ends at the platform 24 close to the ground. From this platform the luggage is displaced by the displacement means of the loading device e.g. a sucking disc and moved to the waiting luggage vans 20 where it may be off-loaded. When off-loading large amounts of luggage the ability of the pole 2 to rotate prevent the need for moving the luggage vans 20 each time one van has been filled with luggage due to that the pole 2 may be rotated after the on-loading of luggage and situated for on-loading at one of the other luggage vans placed close to the aircraft 19 and vehicle 1.

1. Loading device for on- and off-loading of cargo such as parcels, sacks, baggage and luggage wherein the loading device contains a pole and a cable, said pole is at the proximal end attached to a platform, where said platform defines a plane, said cable is arranged between the distal end of the pole and the means for displacement of cargo, which means for displacement is free to perform a pendular motion forced by manually displacement.

2. Loading device according to claim 1 wherein the pole is telescopic, such that the pole may be extended from a storage position to a fully extended state or any desired length in between.

3. Loading device according to claim 1 wherein the loading device has the cable arranged on a winch, and said winch is situated beside the proximal end of the pole.

4. Loading device according to claim 3 wherein said winch contains sensor means, said sensor means automatically balancing the tension force of said cable according to the load on the means for displacement of luggage keeping the means for displacement in a predefined height.

5. Loading device according to claim 1 wherein the cable is made of an elastic or resilient material, optionally as a tube suitable for vacuum.

6. Loading device according to claim 1 wherein the pole comprises means for rotating the pole around an axis at the proximal end, where said axis is arranged vertical to the plane of the platform.

7. Loading device according to claim 1 wherein the pole comprises means arranged at the proximal end, which means can alter the elevation of the poles distal end relative to the plane of the platform.

8. Loading device according to claim 1 wherein the means for displacement of cargo arranged at the end of the cable consists of a flat plate, a fork, a hook or suction means.

9. Loading device according to claim 1 wherein said platform is placed upon a vehicle or trailer or said platform is an integrated part of a vehicle or trailer.

10. Method for manually moving cargo by means of a pendular movement arising from the displacement of a cable, said cable falls vertically from the distal end of a pole, which pole at its proximal end is attached to a platform.
